(19) United States
(12) Patent Application Publication
(10) Pub. No.: US 2015/0100913 A1
(43) Pub. Date: Apr. 9, 2015

(54) METHOD FOR PROVIDING PERSONALIZED VIRTUAL KEYBOARD

(71) Applicant: Minfotech Co., Ltd, Gwangju (KR)

(72) Inventor: Seung Bae Park, Hwasun-gun (KR)

(21) Appl. No.: 14/388,660

(22) PCT Filed: Mar. 27, 2013
(86) PCT No.: PCT/KR2013/002521

§ 371 Date: Dec. 18, 2014

(30) Foreign Application Priority Data
Mar. 27, 2012 (KR) 10-2012-0031085

(51) Int. Cl. G06F 3/0488; G06F 3/0486

(52) U.S. Cl. CPC G06F 3/04886; G06F 3/0486
USPC 715/773

(57) ABSTRACT

The present invention relates to generating and providing a personalized virtual keyboard in accordance with personal information inputted by a user. A method for providing a personalized virtual keyboard according to an embodiment of the present invention, the method providing a personalized virtual keyboard on a screen so as for a user to input personal information, includes: a first step of generating and storing a personalized virtual keyboard including character keys forming the personal information and having a same or less number of keys than the number of character keys on a default virtual keyboard; and a second step of displaying the personalized virtual keyboard on the screen when the personal information is being inputted.

### TECHNICAL FIELD

The present invention relates to a method for providing a personalized virtual keyboard, and more specifically, to a method for generating and providing a personalized virtual keyboard according to personal information desired by a user to input.

### BACKGROUND ART

In the modern information society, a number of information devices of various types (e.g., personal computers (PCs), smartphones, tablet computers, automated financial terminals, automatic ticket vending machines, access control systems, and the like) exist. Most of these information devices include an input means for allowing a user to input information, and a virtual keyboard graphically displayed on a screen tends to be used as the input means. As a representative example, a virtual keyboard is displayed on a monitor in online banking using a PC so as for a user to input personal information, such as an account password, a security card number, and the like, by using a mouse.

Recently, the number of users using personal portable terminal information devices, such as smartphones, tablet computers, and the like, is rapidly increasing. The users access the Internet by using the personal portable terminal information devices to process various personal works (checking and sending e-mails, financial activities, web shopping, and the like) and enjoy leisure activities (viewing movie, gaming, and the like). Typically, such a smartphone or tablet computer does not include a separate keyboard device but displays a virtual keyboard on a touch screen to receive personal information (an identification (ID), a password, and the like) of a user through the virtual keyboard, wherein the personal information includes a digital certificate password, an Internet personal identification number (i-PIN) ID, an i-PIN password, a bankbook or card password, a game item transaction password, and the like.

At present, a widely used virtual keyboard is formed by a typical QWERTY keyboard layout, i.e., formed so that a selective input is possible by arranging characters and numbers on respective keys of the QWERTY keyboard layout. However, when a virtual keyboard of the QWERTY keyboard layout is applied to an information and technology (IT) information device having a small-sized screen, such as a smartphone, the size of each key is small, and thus, it is difficult to recognize a character or number allocated to each key, and an input error may occur by touching a wrong adjacent key in touching a key. When only numbers are displayed on the QWERTY keyboard layout to increase readability, although the size of a button is large, it is impossible to conveniently input personal information by using drag and drop or the like.

### DETAILED DESCRIPTION OF THE INVENTION

### Technical Problem

The present invention provides a method for providing a personalized virtual keyboard including some keys according to personal information desired by a user to input.

### Technical Solution

According to an aspect of the present invention, there is provided a method for providing a personalized virtual keyboard on a screen so as for a user to input personal information, the method including: a first step of generating and storing a personalized virtual keyboard including character keys forming the personal information and having a same or less number of keys than the number of character keys on a default virtual keyboard; and a second step of displaying the personalized virtual keyboard on the screen when the personal information is being inputted.

### Advantageous Effects

According to one or more embodiments of the present invention, when a user desires to input personal information by using an IT information device, a personalized virtual keyboard including character keys for inputting the personal information and having a less number of keys than a total number of keys is provided, and thus, the size of each key displayed on a screen may be large, and accordingly, the user may more conveniently and accurately input the personal information than before.

In addition, the information device transmits selection information of character keys to a server, and the server recognizes a character string inputted by the user from the selection information, and thus, no trace of the personal information inputted by the user is left in a communication network or the information device, thereby preventing the risk of leaking the personal information to the outside.

### DESCRIPTION OF THE DRAWINGS

FIG. 1 is a block diagram of a system for providing a personalized virtual keyboard, according to an embodiment of the present invention;

FIG. 2 is a flowchart of a process by which an information device sets a personalized virtual keyboard, according to an embodiment of the present invention;

FIGS. 2A to 2I are flowcharts of various examples of the process of setting a personalized virtual keyboard in FIG. 2;

FIG. 2J is a table of characters forming personal information;

FIG. 2K illustrates a configuration of information device side key data, and FIG. 2L illustrates a configuration of server side key data;

FIG. 2M illustrates a result of an exclusive OR (XOR) operation of the information device side key data of FIG. 2K and the server side key data of FIG. 2L, and FIG. 2N illustrates characters corresponding to 1 as a result value of the XOR operation of the information device side key data and the server side key data;

FIG. 3 illustrates a personal information input screen (e.g., a login webpage);

FIG. 4 illustrates a default virtual keyboard displayed on the personal information input screen;

FIG. 5 is a flowchart of a process by which an information device displays a personalized virtual keyboard, according to an embodiment of the present invention;

FIGS. 6A and 6B illustrate a personalized virtual keyboard corresponding to personal information which is supposed to be inputted by a user, according to an embodiment of the present invention;

FIGS. 7, 8A, and 8B illustrate arrangements of character keys forming a personalized virtual keyboard, according to embodiments of the present invention;

FIGS. 9A and 9B illustrate menu keys of a personalized virtual keyboard, according to embodiments of the present invention;

FIGS. 10A and 10B illustrate pattern design key manipulation screen images;

FIG. 11 illustrates a character invisible key manipulation screen image;

FIGS. 12A and 12B illustrate setup key manipulation screen images;

FIGS. 13A and 13B illustrate a button number setup screen image and a result screen image;

FIG. 14 illustrates a process of performing user authentication based on key selection information; and

FIG. 15 illustrates a process of performing user authentication based on key selection information and position change information.

### BEST MODE

Hereinafter, a method for providing a personalized virtual keyboard, according to an embodiment of the present invention, will be described in more detail with reference to the accompanying drawings.

In the specification of the present invention, “character” is an arbitrary symbol forming personal information desired by a user to input and is used as the meaning including all of alphabet, number, Korean character, and special character. Commonly, keys forming a virtual keyboard include one or more characters (alphabet, number, Korean character, and special character) corresponding to a corresponding key, and the user inputs personal information in an input window by sequentially selecting character keys corresponding to the personal information.

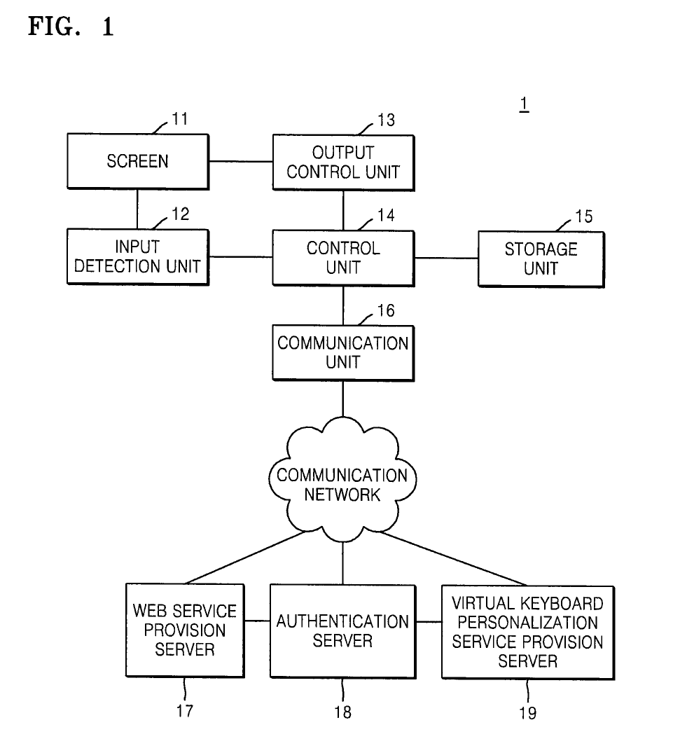

FIG. 1 is a block diagram of a system for providing a personalized virtual keyboard, according to an embodiment of the present invention.

An information device 1 to which the present invention is applied includes a screen 11, an input detection unit 12, an output control unit 13, a control unit 14, a storage unit 15, and a communication unit 16. The screen 11 may be a typical display only device (e.g., a monitor) or a touch screen through which both an image output and an information input are possible. When a user performs a selection by touching the screen 11 with a finger or a separate pointing device not shown, the input detection unit 12 recognizes the selection and provides the recognized result to the control unit 14. The output control unit 13 displays an image formed by the control unit 14 on the screen 11. The control unit 14 acquires personalized virtual keyboard information of the user from the storage unit 15 or the communication unit 16, forms a personalized virtual keyboard image according to an embodiment of the invention, displays the personalized virtual keyboard image on the screen 11 via the output control unit 13, recognizes a menu or keys selected by the user by means of the input detection unit 12, and stores inputted symbols in the storage unit 15. The storage unit 15 stores information (e.g., menu input information, inputted personal information character string information, and character key selection information) inputted by the user, the personalized virtual keyboard information of the user, and a program for carrying out the method for providing a personalized virtual keyboard, according to an embodiment of the present invention, under control of the control unit 14. The communication unit 16 communicates with a server at a remote place via a wired communication network or a wireless communication network.

The server with which the information device 1 communicates through the communication unit 16 may include a web service provision server 17 for providing a web service requested by the user to the information device 1, an authentication server 18 for performing user authentication based on personal information inputted into the information device 1 when the user requests for the web service, a virtual keyboard personalization service provision server 19 for allowing the information device 1 to provide a personalized virtual keyboard of the user when the user inputs the personal information for the user authentication, and the like. Herein, any two or more of the web service provision server 17, the authentication server 18, and the virtual keyboard personalization service provision server 19 may be physically implemented as one system, or the web service provision server 17, the authentication server 18, and the virtual keyboard personalization service provision server 19 may be individually implemented. In the specification of the present invention, the web service provision server 17 includes a server for providing services by means of an application programs (including applications (Apps))

The user sequentially selects character keys corresponding to the personal information by using the personalized virtual keyboard displayed on the screen 11 of the information device 1, and the selected information is recognized by the input detection unit 12 and is transmitted to the control unit 14. The control unit 14 requests for authentication by transmitting personal information character string information or character key selection information inputted by the user by means of the personalized virtual keyboard to the web service provision server 17 or the authentication server 18 through the communication unit 16.

The information device 1 downloads the program for carrying out the method for providing a personalized virtual keyboard, according to an embodiment of the present invention, from the virtual keyboard personalization service provision server 19. When the information device 1 accesses the web service provision server 17, the information device 1 downloads the latest version of the program for carrying out the method for providing a personalized virtual keyboard, according to an embodiment of the present invention, from the virtual keyboard personalization service provision server 19 and executes the downloaded program.

Although the web service provision server 17 is shown in FIG. 1, the idea of the present invention is not limited thereto, and various application programs (Apps) to be provided through a smartphone may also be included in the idea of the present invention.

That is, in a web, when a personalized virtual keyboard is installed in a server, and an information device tries to log in, the server may transmit a login page and a personalized virtual keyboard program to the information device. Alternatively, an application program (including App) may include a personalized virtual keyboard as a service part. For example, when an information device tries to log in by downloading an application program service provided with a personalized virtual keyboard from an application program provision server (App store in case of an App), the server transmits only information or data necessary for the personalized virtual keyboard to the information device instead of transmitting the personalized virtual keyboard to the information device. In other words, a server transmits a personalized virtual keyboard to an information device for every login in a web, whereas an application program (including App) downloaded from a server to an information device includes a personalized virtual keyboard therein. The method for providing a personalized virtual keyboard, according to an embodiment of the present invention, may have the concept including both a method for providing a personalized virtual keyboard in a web and a method for providing a personalized virtual keyboard in an application program.

### MODE OF THE INVENTION

### [Generation and Storage of Personalized Virtual Keyboard]

The method for providing a personalized virtual keyboard, according to an embodiment of the present invention, is largely classified into a process of setting a personalized virtual keyboard according to personal information desired by a user to input and a process of displaying the personalized virtual keyboard according to the personal information on a screen when the user desires to input the personal information.

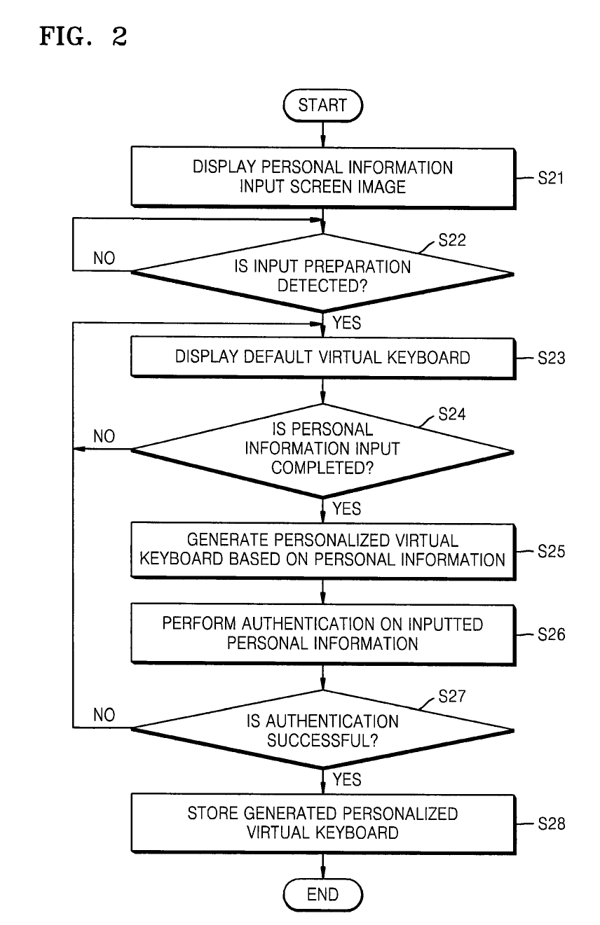

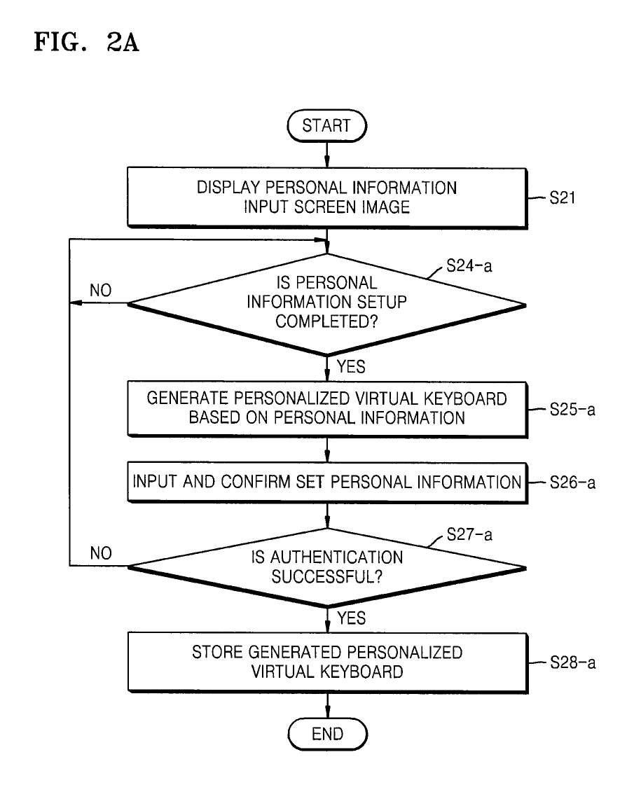

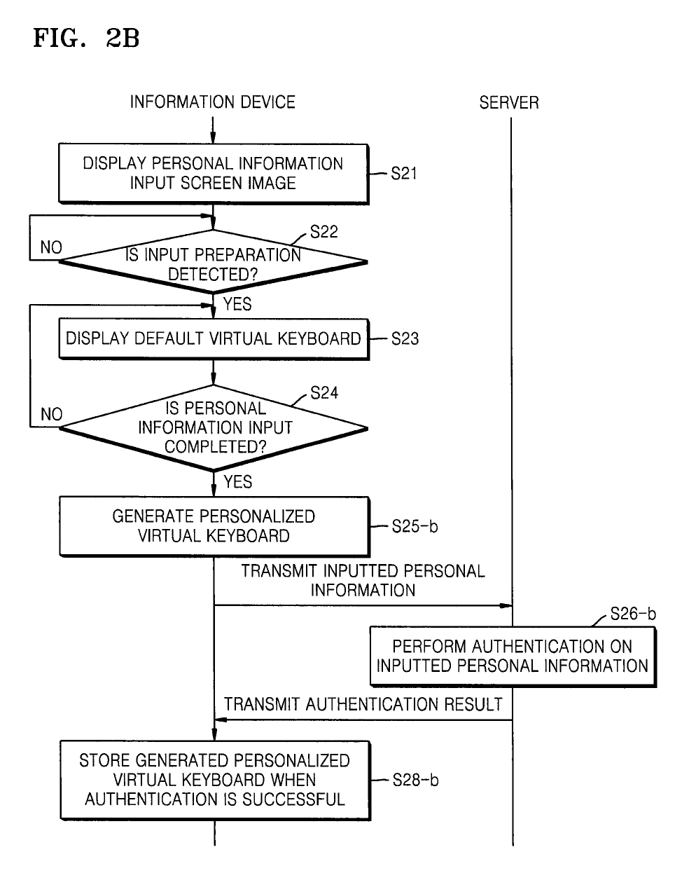

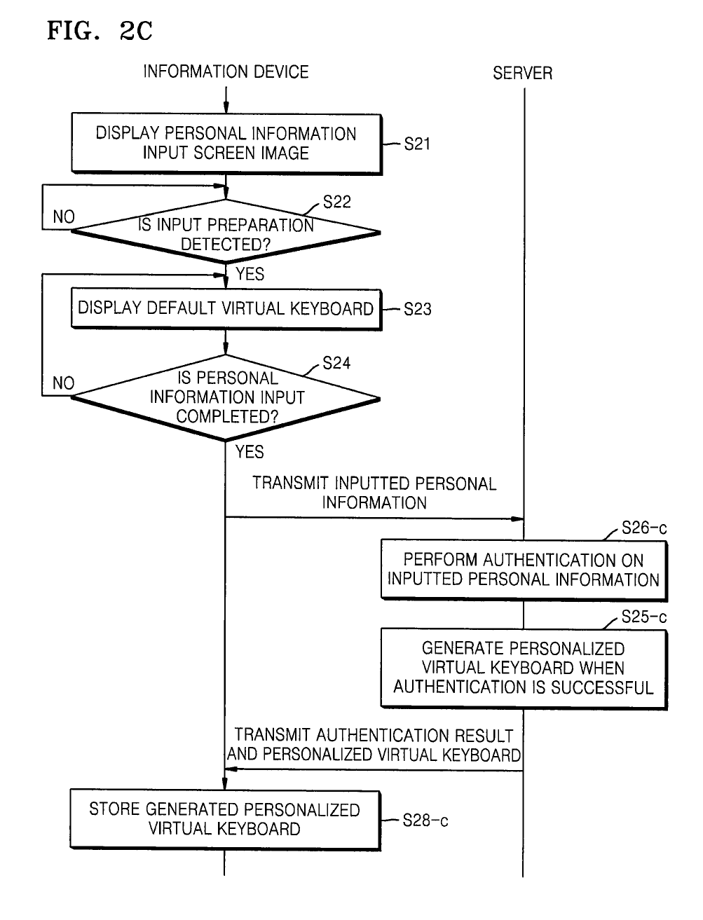

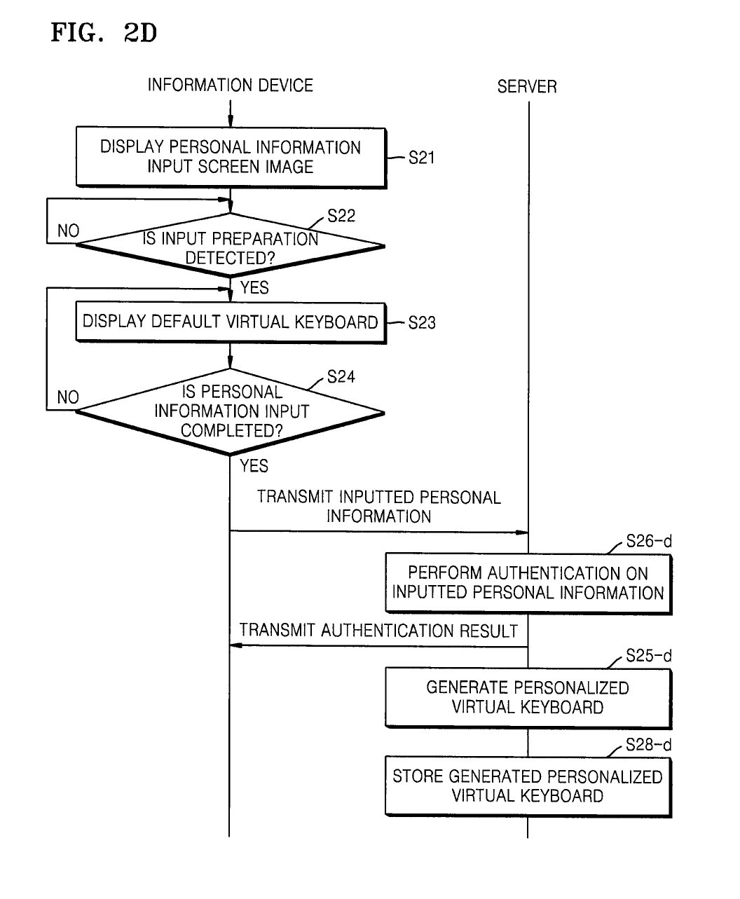

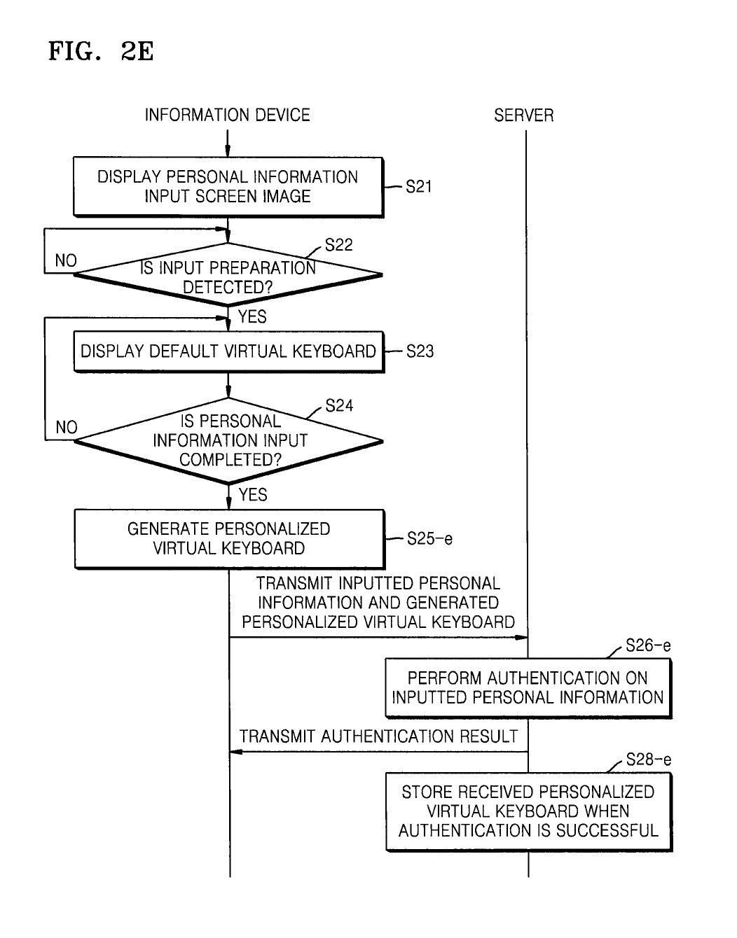

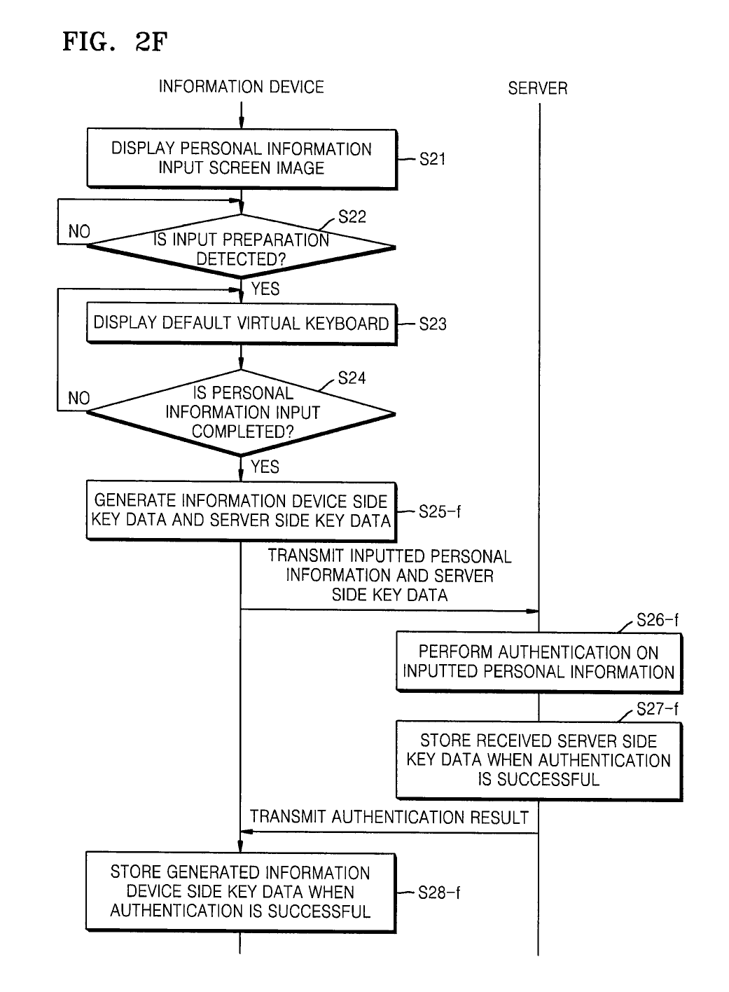

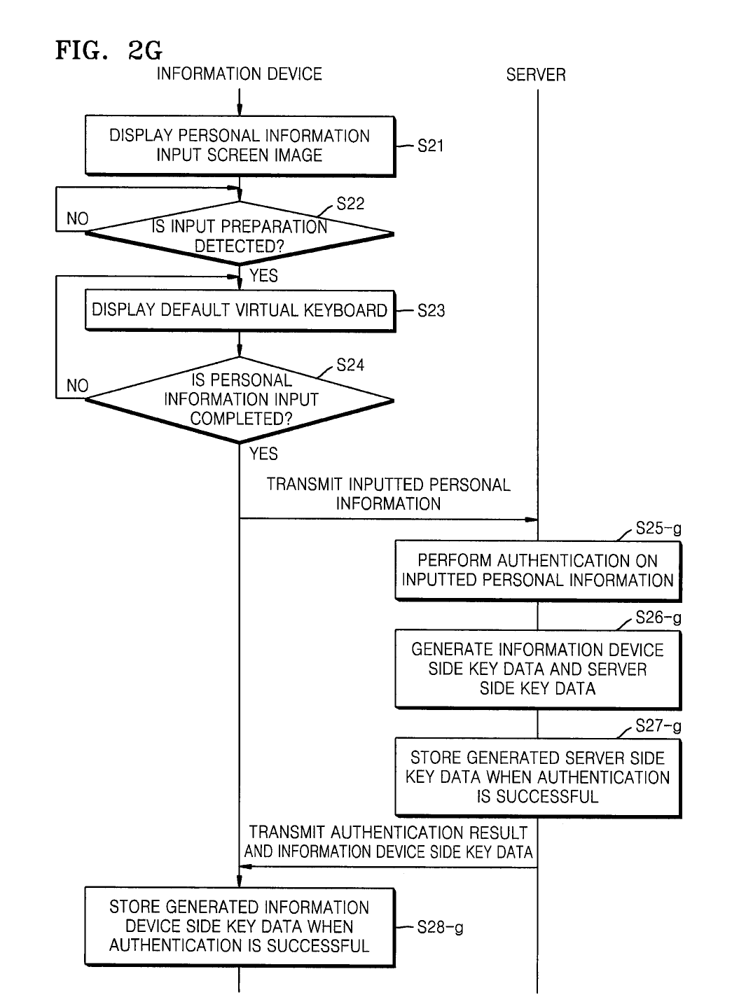

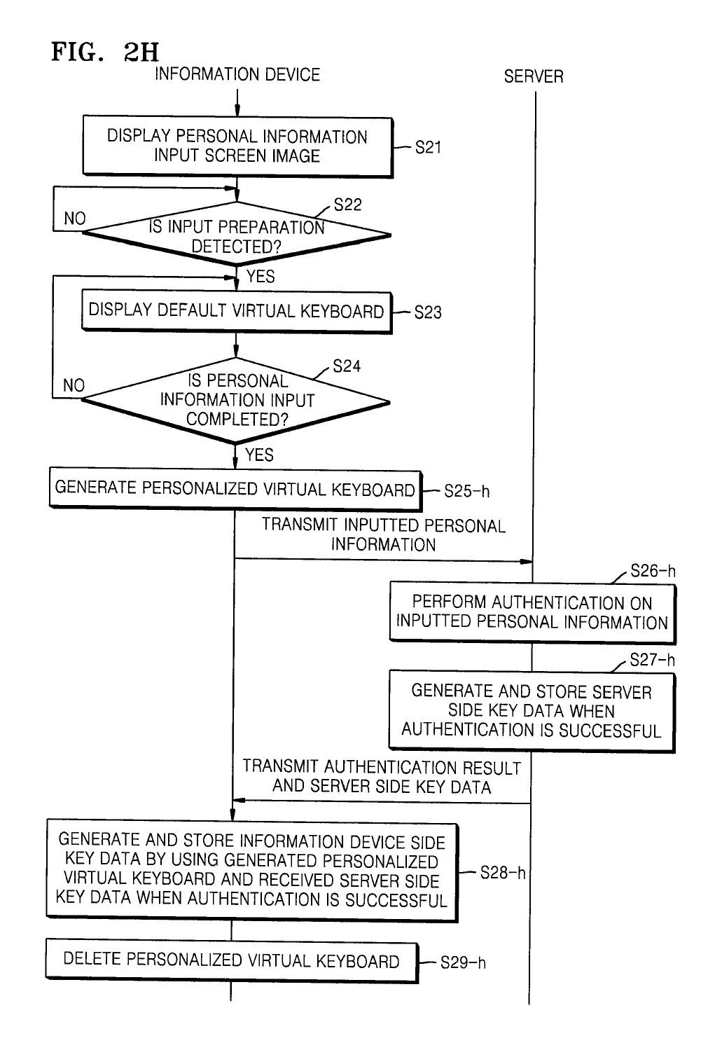

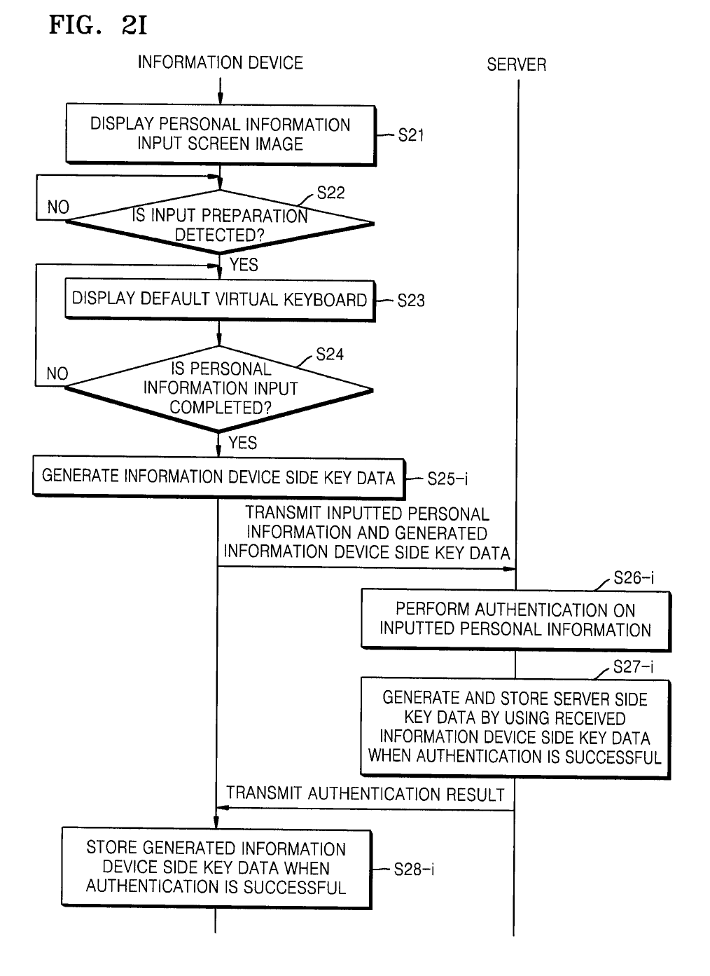

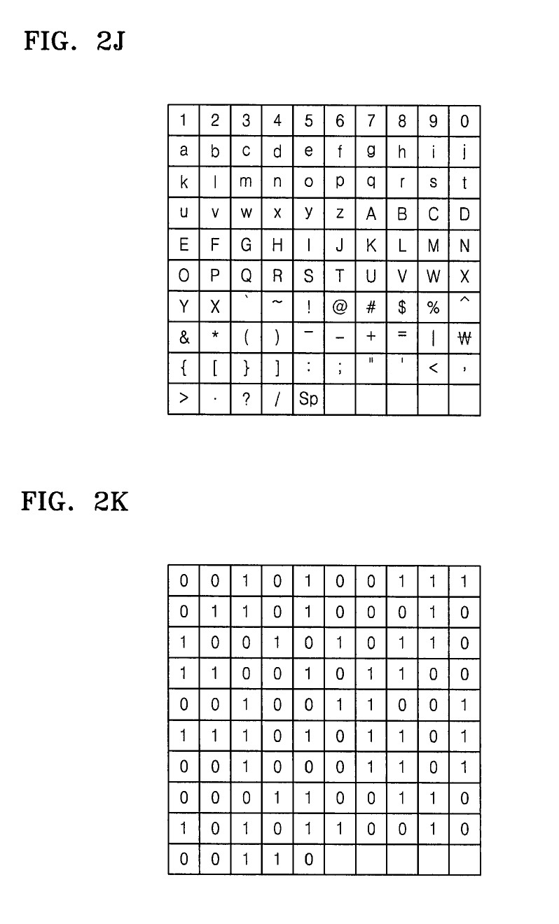

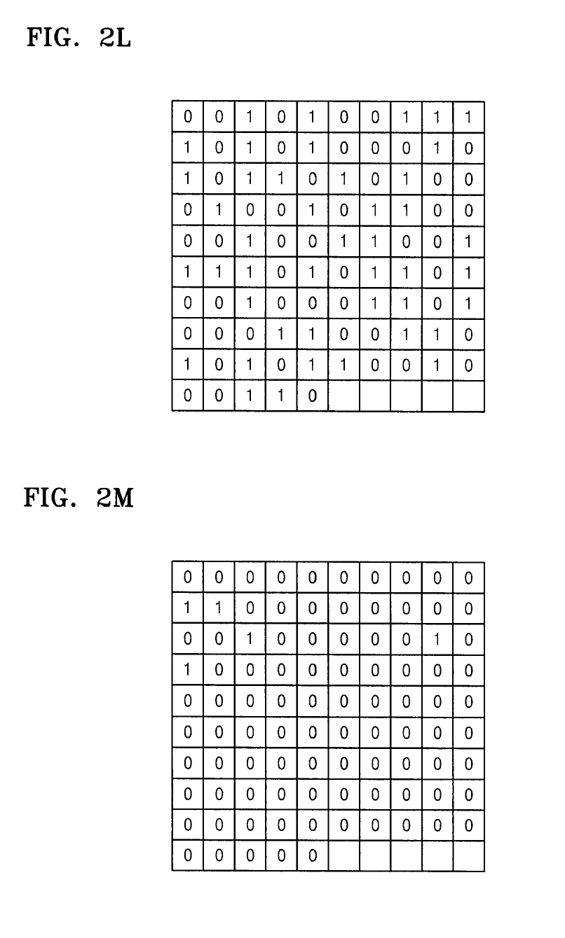

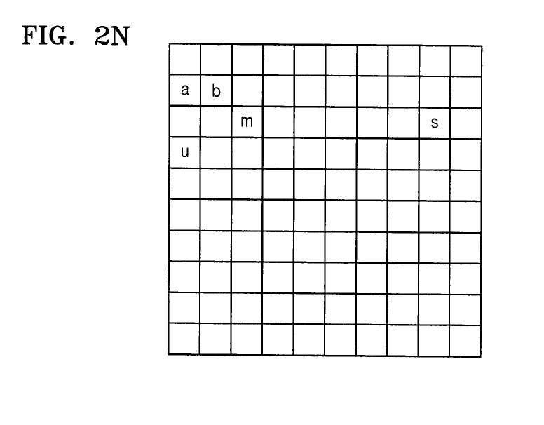

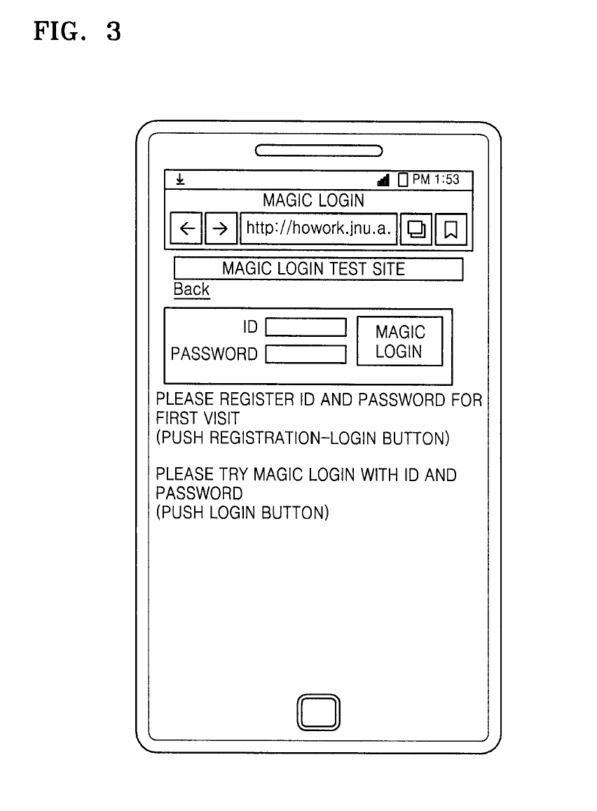

FIG. 2 is a flowchart of a process by which the information device 1 sets a personalized virtual keyboard, according to an embodiment of the present invention. When the user desires to use a web service provided by the web service provision server 17 by accessing the web service provision server 17, the web service provision server 17 commonly performs a process of authenticating personal information of the user. To this end, the web service provision server 17 provides a personal information input screen image to the information device 1 used by the user, and the information device 1 displays the personal information input screen image (e.g., a login webpage, an account number input webpage, other various password input webpages, or the like) on the screen 11 as shown in FIG. 3, in operation S21.

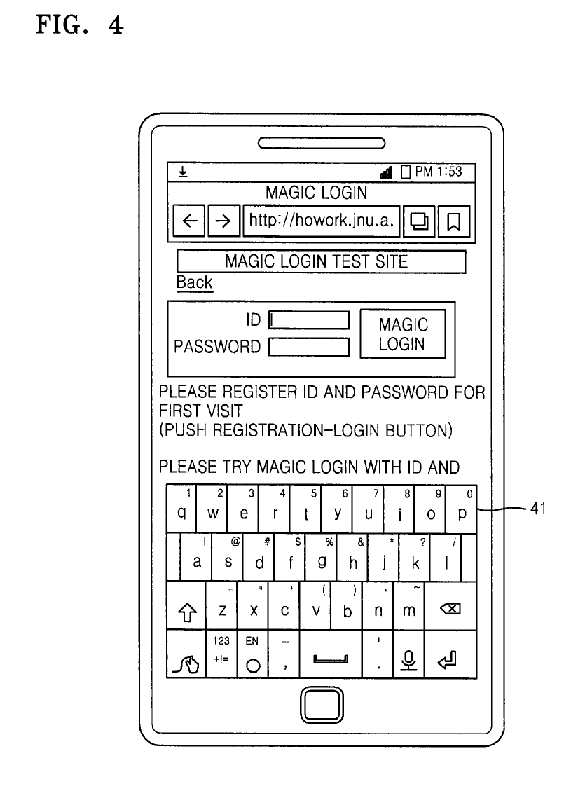

When an input preparation is detected in operation S22 by selecting (touching or clicking), by the user, a personal information input window of the personal information input screen image, the information device 1 displays a default virtual keyboard (refer to 41 of FIG. 4) on the screen 11 in operation S23. Herein, the default virtual keyboard indicates a typical QWERTY keyboard layout but is not limited thereto. That is, the default virtual keyboard may be any virtual keyboard having an arrangement through which any characters belonging to personal information can be inputted. The user inputs the personal information by using the default virtual keyboard displayed on the screen 11, and when completion of the personal information input is detected in operation S24, the control unit 14 generates a personalized virtual keyboard based on the inputted personal information in operation S25. Thereafter, the information device 1 performs authentication on the inputted personal information in operation S26. Herein, as a method of performing authentication on the inputted personal information, the information device 1 may query the authentication server 18 about whether or not to authenticate the inputted personal information and receive the authentication result, or may authenticate the inputted personal information by itself on the basis of personal information of the user, which is stored therein. When the authentication on the personal information inputted by the user is successful in operation S27, the control unit 14 stores the generated personalized virtual keyboard in operation S28.

The control unit 14 may store the personalized virtual keyboard in the storage unit 15, the authentication server 18, or the virtual keyboard personalization service provision server 19 or may divide and store the personalized virtual keyboard in the storage unit 15 and the authentication server 18 or the virtual keyboard personalization service provision server 19. The personalized virtual keyboard includes character keys necessary for inputting the personal information and has a less number of keys than the number of keys on the default virtual keyboard. A detailed process of generating the personalized virtual keyboard based on the personal information will be described below. The personalized virtual keyboard is encrypted based on an encryption scheme and stored in the storage unit 15, or is encrypted by the authentication server 18 or the virtual keyboard personalization service provision server 19 and transmitted to the information device 1.

When two or more personal information input windows exist in the same personal information input screen image, a separate personalized virtual keyboard for each personal information is generated and stored. For example, for the login webpage as shown in FIG. 3, when an ID input window is selected and an ID is inputted, a personalized virtual keyboard based on the inputted ID is generated, and when a password input window is selected and a password is inputted, a personalized virtual keyboard based on the inputted password is generated.

Also, a lately inputted personalized virtual keyboard may be stored for each personal information input screen image, or separate user identification information may be inputted to store a separate personalized virtual keyboard for each user identification information. For example, for the login webpage as shown in FIG. 3, the ID input window may be selected to input user identification information through the default virtual keyboard, and thereafter, when the password input window is selected, a personalized virtual keyboard based on a password may be generated and displayed. As another example, user identification information may be acquired by completing primary authentication based on a user ID, and a personalized virtual keyboard based on personal information, which is supposed to be inputted by a corresponding user in secondary authentication (when an account number and a password for a game item transaction or an account transfer are inputted), may be stored and displayed.

Hereinafter, various cases according to locations where a generated personalized virtual keyboard is stored will be described in more detail.

First, a case where a generated personalized virtual keyboard is stored only in the storage unit 15 of the information device 1 when the information device 1 is executed alone without a communication environment will now be described. FIG. 2A is a flowchart of an embodiment of the process of setting a personalized virtual keyboard in FIG. 2.

In this case, the operation of inputting personal information in FIG. 2 (operation S24) corresponds to an operation of setting personal information (password) in FIG. 2A (operation S24-a). The operation of generating a personalized virtual keyboard in FIG. 2 (operation S25) corresponds to an operation of generating a personalized virtual keyboard in FIG. 2A (operation S25-a). The operation of performing authentication of the inputted personal information in FIG. 2 (operation S26) corresponds to an operation of inputting and confirming the set personal information in FIG. 2A (operation S26-a). When the authentication on the personal information inputted by the user is successful in operation S27-a, the generated personalized virtual keyboard is stored in operation S28-a. In this case, for a normal user, a previously inputted password may be the same as the currently inputted password.

For example, if a lock is released through password authentication when a smartphone (the information device 1) is turned on, when the user selects a personal information (password) setup, the control unit 14 generates a personalized virtual keyboard. Thereafter, personal information (password) is inputted into an input window on the screen 11 and confirmed, and only if a previously inputted password is the same as the currently inputted password, the control unit 14 stores the generated personalized virtual keyboard.

Next, a case where a generated personalized virtual keyboard is stored only in the storage unit 15 of the information device 1 in a communication environment will now be described. FIGS. 2B and 2C are flowcharts of embodiments of the case where a generated personalized virtual keyboard is stored only in the information device 1, in the process of setting a personalized virtual keyboard in FIG. 2.

Referring to FIG. 2B, the user inputs personal information by using the default virtual keyboard displayed on the screen 11, and when completion of the personal information input is detected in operation S24, the information device 1 generates a personalized virtual keyboard based on the inputted personal information in operation S25-b. Thereafter, the information device 1 transmits the inputted personal information to the authentication server 18 or the virtual keyboard personalization service provision server 19, and the authentication server 18 or the virtual keyboard personalization service provision server 19 performs authentication on the transmitted personal information in operation S26-b and transmits the authentication result to the information device 1. In operation S28-b, the control unit 14 of the information device 1 stores the personalized virtual keyboard generated based on the personal information in the storage unit 15 when the authentication is successful.

Referring to FIG. 2C, the user inputs personal information by using the default virtual keyboard displayed on the screen 11, and when completion of the personal information input is detected in operation S24, the information device 1 transmits the inputted personal information to the authentication server 18 or the virtual keyboard personalization service provision server 19, and the authentication server 18 or the virtual keyboard personalization service provision server 19 performs authentication on the transmitted personal information in operation S26-c and generates a personalized virtual keyboard based on the inputted personal information when the authentication is successful in operation S25-c. Thereafter, the authentication server 18 or the virtual keyboard personalization service provision server 19 transmits the authentication result and the generated personalized virtual keyboard to the information device 1. In operation S28-c, the control unit 14 of the information device 1 stores the received personalized virtual keyboard in the storage unit 15.

Next, a case where a generated personalized virtual keyboard is stored only in the authentication server 18 or the virtual keyboard personalization service provision server 19 in a communication environment will now be described. FIGS. 2D and 2E are flowcharts of embodiments of the case where a generated personalized virtual keyboard is stored only in a server, in the process of setting a personalized virtual keyboard in FIG. 2.

Referring to FIG. 2D, the user inputs personal information by using the default virtual keyboard displayed on the screen 11, and when completion of the personal information input is detected in operation S24, the information device 1 transmits the inputted personal information to the authentication server 18 or the virtual keyboard personalization service provision server 19, and the authentication server 18 or the virtual keyboard personalization service provision server 19 performs authentication on the transmitted personal information in operation S26-d and transmits the authentication result to the information device 1. When the authentication is successful, the authentication server 18 or the virtual keyboard personalization service provision server 19 generates a personalized virtual keyboard based on the inputted personal information in operation S25-d and stores the generated personalized virtual keyboard in operation S28-d.

Referring to FIG. 2E, the user inputs personal information by using the default virtual keyboard displayed on the screen 11, and when completion of the personal information input is detected in operation S24, the information device 1 generates a personalized virtual keyboard based on the inputted personal information in operation S25-e and transmits the inputted personal information and the generated personalized virtual keyboard to the authentication server 18 or the virtual keyboard personalization service provision server 19. The authentication server 18 or the virtual keyboard personalization service provision server 19 performs authentication on the transmitted personal information in operation S26-e and transmits the authentication result to the information device 1. When the authentication is successful, the authentication server 18 or the virtual keyboard personalization service provision server 19 stores the received personalized virtual keyboard in operation S28-e.

Next, a case where information for generating a personalized virtual keyboard is stored in both the information device 1 and the authentication server 18 or the virtual keyboard personalization service provision server 19 in a communication environment will now be described. FIGS. 2F to 2I are flowcharts of embodiments of the case where information for generating a personalized virtual keyboard is stored in both the information device 1 and a server, in the process of setting a personalized virtual keyboard in FIG. 2.

In this case, a specific portion other than the embodiments described above is to generate a personalized virtual keyboard by individually storing key data for generating the personalized virtual keyboard in each of the information device 1 and the server and combining the key data stored in the information device 1 and the server if necessary instead of directly storing the personalized virtual keyboard in any one of the information device 1 and the server. This case will now be described in more detail.

Referring to FIG. 2F, the user inputs personal information by using the default virtual keyboard displayed on the screen 11, and when completion of the personal information input is detected in operation S24, the information device 1 generates information device side key data and server side key data in operation S25-f. Thereafter, the information device 1 transmits the inputted personal information and the generated server side key data to the authentication server 18 or the virtual keyboard personalization service provision server 19. In operation S26-f, the authentication server 18 or the virtual keyboard personalization service provision server 19 performs authentication on the transmitted personal information. If the authentication is successful as the authentication result, the authentication server 18 or the virtual keyboard personalization service provision server 19 stores the received server side key data in operation S274 and transmits the authentication result to the information device 1. In operation S28-f, the information device 1 stores the generated information device side key data when the authentication is successful.

Referring to FIG. 2G, the user inputs personal information by using the default virtual keyboard displayed on the screen 11, and when completion of the personal information input is detected in operation S24, the information device 1 transmits the inputted personal information to the authentication server 18 or the virtual keyboard personalization service provision server 19. The authentication server 18 or the virtual keyboard personalization service provision server 19 performs authentication on the transmitted personal information in operation S25-g and generates information device side key data and server side key data in operation S26-g. If the authentication is successful as the authentication result, the authentication server 18 or the virtual keyboard personalization service provision server 19 stores the generated server side key data in operation S27-g and transmits the authentication result and the generated information device side key data to the information device 1. In operation S28-g, the information device 1 stores the transmitted information device side key data when the authentication is successful.

Referring to FIG. 2H, the user inputs personal information by using the default virtual keyboard displayed on the screen 11, and when completion of the personal information input is detected in operation S24, the information device 1 generates a personalized virtual keyboard in operation S25-h and transmits the inputted personal information to the authentication server 18 or the virtual keyboard personalization service provision server 19. The authentication server 18 or the virtual keyboard personalization service provision server 19 performs authentication on the transmitted personal information in operation S26-h, and generates and stores server side key data in operation S27-h when the authentication is successful. Thereafter, the authentication server 18 or the virtual keyboard personalization service provision server 19 transmits the authentication result and the generated server side key data to the information device 1. In operation S28-h, the information device 1 generates and stores information device side key data by using the generated personalized virtual keyboard and the received server side key data when the authentication is successful. Finally, the information device 1 deletes the generated personalized virtual keyboard in operation S29-h.

Referring to FIG. 21, the user inputs personal information by using the default virtual keyboard displayed on the screen 11, and when completion of the personal information input is detected in operation S24, the information device 1 generates information device side key data in operation S25-i. Thereafter, the information device 1 transmits the inputted personal information and the generated information device side key data to the authentication server 18 or the virtual keyboard personalization service provision server 19. The authentication server 18 or the virtual keyboard personalization service provision server 19 performs authentication on the transmitted personal information in operation S26-i. If the authentication is successful, the authentication server 18 or the virtual keyboard personalization service provision server 19 generates and stores server side key data by using the received information device side key data in operation S27-i. Thereafter, the authentication server 18 or the virtual keyboard personalization service provision server 19 transmits the authentication result to the information device 1. In operation S28-i, the information device 1 stores the generated information device side key data when the authentication is successful.

Hereinafter, a method of generating a personalized virtual keyboard by using information device side key data and server side key data when information for generating the personalized virtual keyboard is stored in both the information device 1 and a server as shown in FIGS. 2F to 21 will be described.

FIG. 2J is a table of characters forming personal information. FIG. 2J illustrates a total of 95 characters forming personal information. In detail, a total of 95 characters including 10 numbers 52 capital letters and lowercase letters of alphabet, 32 specific characters, and space form a default virtual keyboard. Herein, a default virtual keyboard may not include all of the 95 characters, and the 95 characters may be considered as a set of keys with which personal information is formed, wherein subsets obtained by dividing the set of keys indicate default virtual keyboards, and one default virtual keyboard may have a key for moving to another default virtual keyboard. For example, when a default virtual keyboard is provided with numbers, a set of keys which may belong to personal information includes numbers, and this set may be entirely displayed on one virtual keyboard without division, and thus, the default virtual keyboard may display all the numbers thereon.

FIG. 2K illustrates a configuration of information device side key data, and FIG. 2L illustrates a configuration of server side key data. As shown in FIGS. 2K and 2L, each of the information device side key data and the server side key data is provided with a 95-bit bit string. The number of bits is the same as the total number of characters forming a default virtual keyboard.

FIG. 2M illustrates a result of an exclusive OR (XOR) operation of the information device side key data of FIG. 2K and the server side key data of FIG. 2L, and FIG. 2N illustrates characters corresponding to 1 as a result value of the XOR operation of the information device side key data and the server side key data. That is, a personalized virtual keyboard having the characters of which a result value of the XOR operation of the information device side key data and the server side key data is 1, and is displayed on a personal information input screen image.

Alternatively, a limited number of pieces (e.g., 10,000 pieces) of server side key data may be used, and information device side key data may vary for each information device. This case corresponds to only a case of generating information device side key data by using server side key data. In this case, a server manager may determine which information device uses which server side key data.

Alternatively, when information for generating a personalized virtual keyboard is stored in both an information device and a server, the number of pieces of server side key data may be 1 and information device side key data may vary according to personal information, or the number of pieces of server side key data may be the number of pieces of personal information (for an ID and a password, the number of pieces of personal information is 2) and information device side key data may correspond to the server side key data.

### [Display Personalized Virtual Keyboard]

After setting a personalized virtual keyboard according to personal information through the process of FIG. 2, the personalized virtual keyboard is displayed on a personal information input screen image.

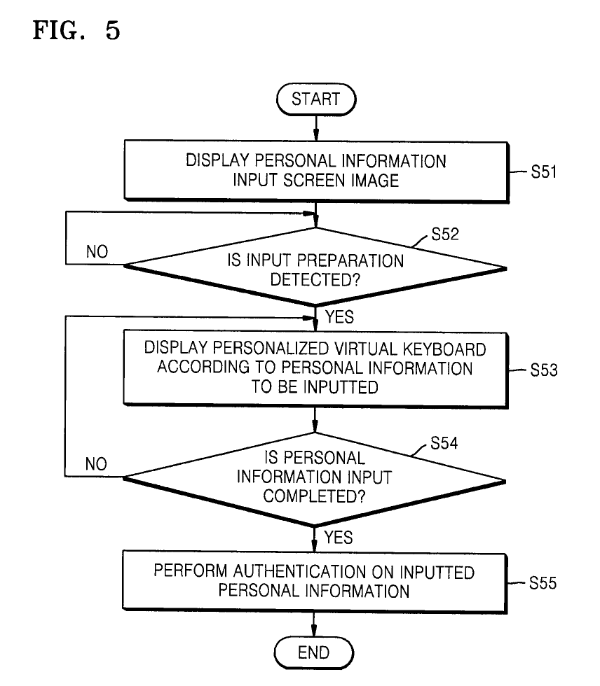

FIG. 5 is a flowchart of a process by which an information device displays a personalized virtual keyboard, according to an embodiment of the present invention.

When the user accesses the web service provision server 17, the information device 1 receives a personal information input screen image as shown in FIG. 3 from the web service provision server 17 and displays the received personal information input screen image on the screen 11 in operation S51.

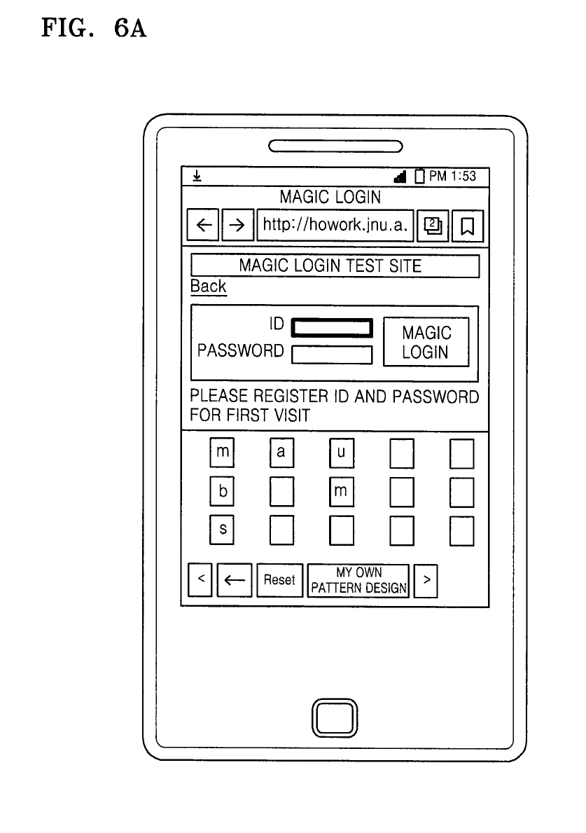

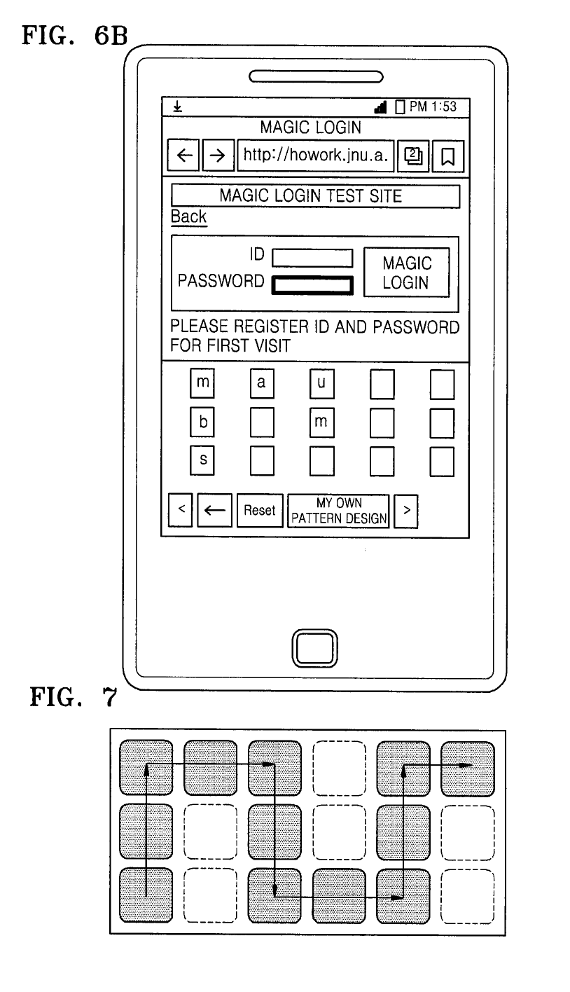

When an input preparation is detected in operation S52 by selecting (touching or clicking), by the user, a personal information input window of the personal information input screen image, the information device 1 reads a personalized virtual keyboard according to personal information, which is supposed to be inputted by the user, and displays the read personalized virtual keyboard on the screen 11 in operation S53, as shown in FIGS. 6A and 6B. FIG. 6A illustrates a personalized virtual keyboard when personal information, which is supposed to be inputted by the user, is an ID (e.g., “sbmaum”), and FIG. 6B illustrates a personalized virtual keyboard when personal information, which is supposed to be inputted by the user, is a password (e.g., “hohoho”). Although all duplicated characters in personal information are displayed in FIGS. 6A and 6B, the present invention is not limited thereto, and duplicated characters may be displayed once. In this case, a vacant button on which no character is displayed may exist on a personalized virtual keyboard.

The user inputs the personal information, which is supposed to be inputted, by using the personalized virtual keyboards. When completion of the personal information input is detected in operation S54, authentication on the inputted personal information is performed in operation S55. Herein, as a method of performing authentication on the inputted personal information, the information device 1 may query the authentication server 18 about whether or not to authenticate the inputted personal information and receive the authentication result, or may authenticate the inputted personal information by itself on the basis of personal information of the user, which is stored therein.

### [Menu and Editing of Personalized Virtual Keyboard]

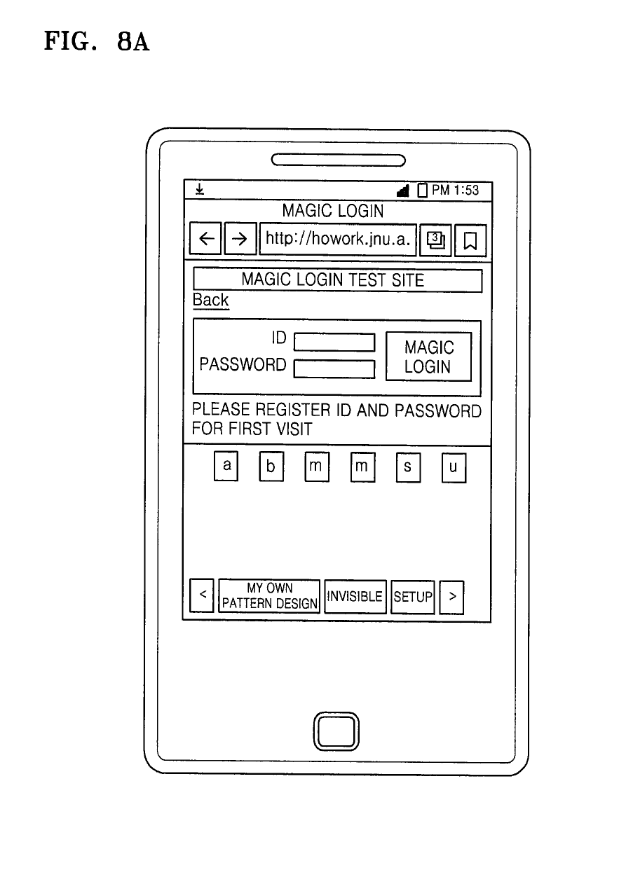

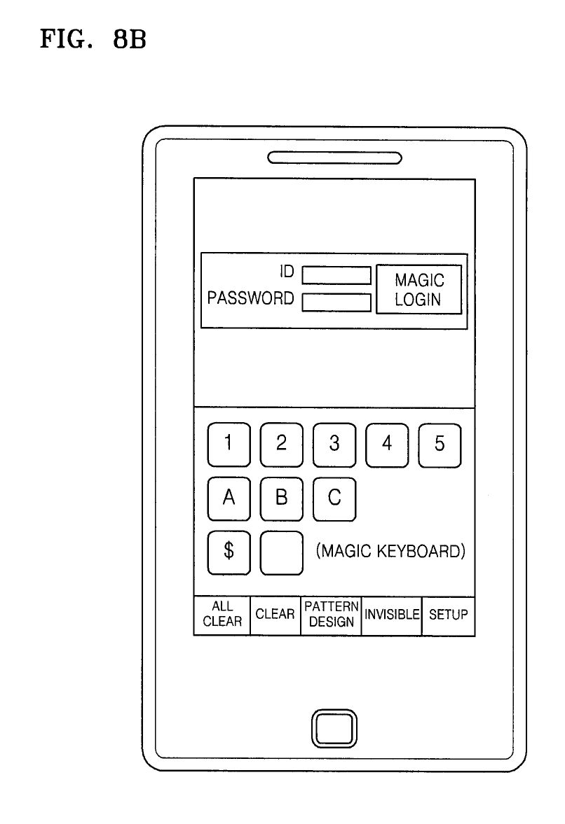

The personalized virtual keyboard generated by the information device 1 in operation S27 of FIG. 2 includes the character keys forming personal information as shown in FIGS. 6A and 6B, and all the character keys are arranged in a specific pattern (e.g., a 90°-rotated Korean character “ [symbol] ” pattern as shown in FIG. 7, a straight pattern as shown in FIG. 8A, a two-dimensional matrix pattern as shown in FIG. 8B, or the like). The pattern in which character keys are arranged may vary. In an arrangement of the two-dimensional matrix pattern as shown in FIG. 8B, the same type of characters (e.g., numbers, alphabet, or specific characters) may be arranged in a specific row or column.

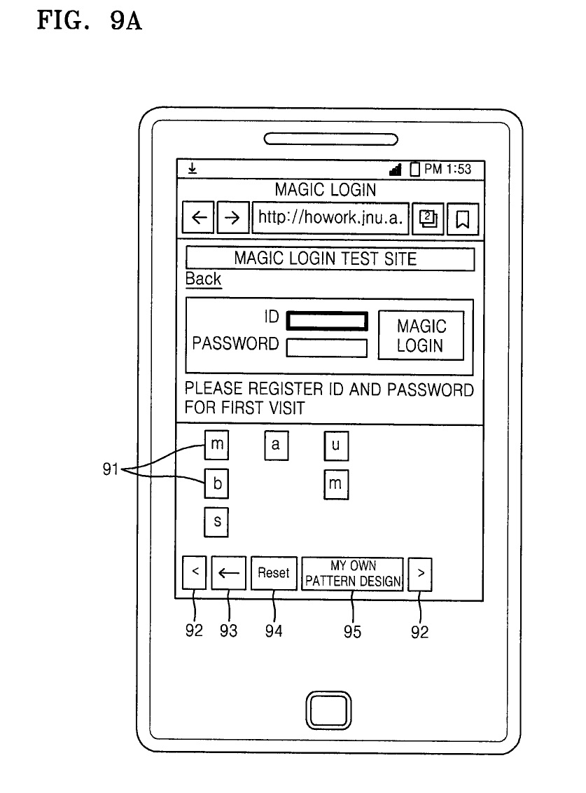

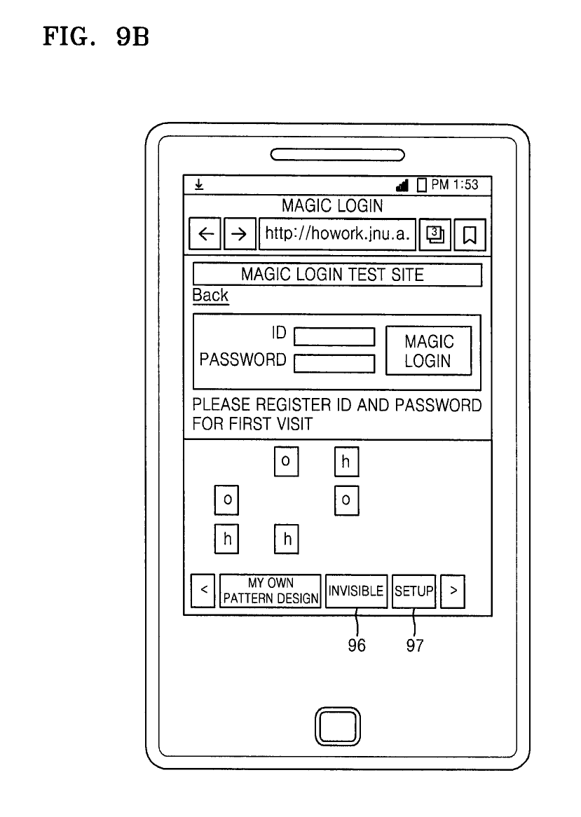

The personalized virtual keyboard includes a plurality of character keys 91, menu shift keys 92, and a plurality menu keys as shown in FIGS. 9A and 9B, wherein the plurality menu keys include a single character erase key 93, an entire character erase key 94, a pattern design key 95, a character invisible key 96, and a setup key 97.

The menu shift keys 92 are keys for manipulating to shift menu keys to the left or right so as to reveal hidden menu keys. The single character erase key 93 is a menu key for manipulating to erase inputted characters one by one. The entire character erase key 94 is a menu key for manipulating to erase inputted characters at once.

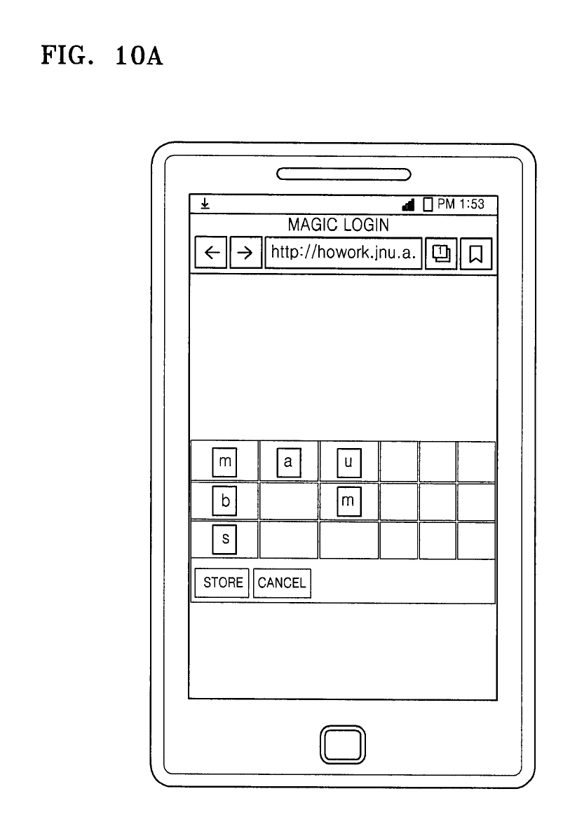

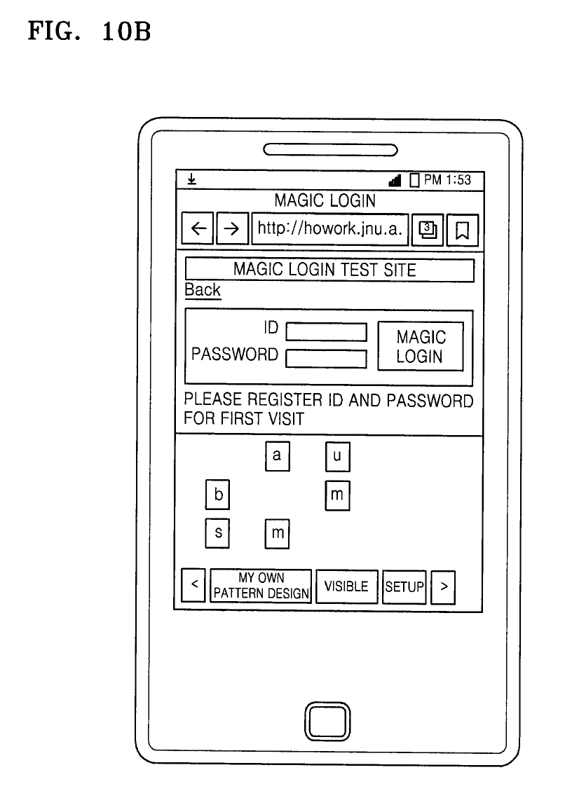

The pattern design key 95 is a menu key for allowing the user to manipulate in order to change an arrangement of character keys forming a personalized virtual keyboard. When the pattern design key 95 is manipulated, character keys forming a personalized virtual keyboard are in a location changeable state as shown in FIG. 10A, and when the user changes and stores locations of desired character keys, the locations of the corresponding character keys are changed and stored as shown in FIG. 10B, and a personalized virtual keyboard of which character locations have been changed appears when personal information is inputted. FIG. 10B illustrates a character key “m” of which a location has been changed to a lower position. Herein, as a method of changing a location of a character key, a corresponding character key may be selected and moved by a drag and drop method, or a character key to be moved may be moved by first selecting the character key to be moved and then selecting a location to which the selected character key is to be moved.

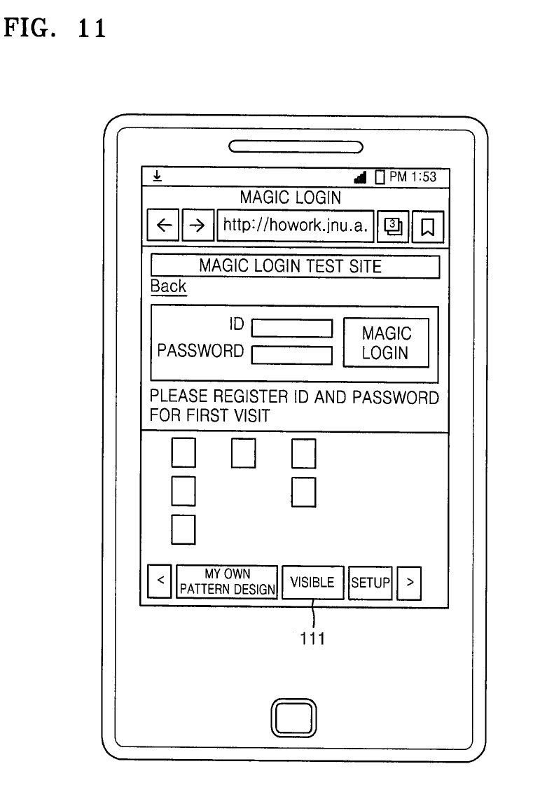

The character invisible key 96 is a menu key for allowing the user to manipulate in order to hide characters displayed on the character keys forming the personalized virtual keyboard. When the character invisible key 96 is manipulated, the characters displayed on the character keys forming the personalized virtual keyboard are hidden and invisible as shown in FIG. 11. When the characters are invisible, the character invisible key 96 is changed to a character visible key 111. Even when the characters are invisible, information on the characters corresponding to the respective character keys is maintained, and thus, a character corresponding to a key touched by the user is inputted.

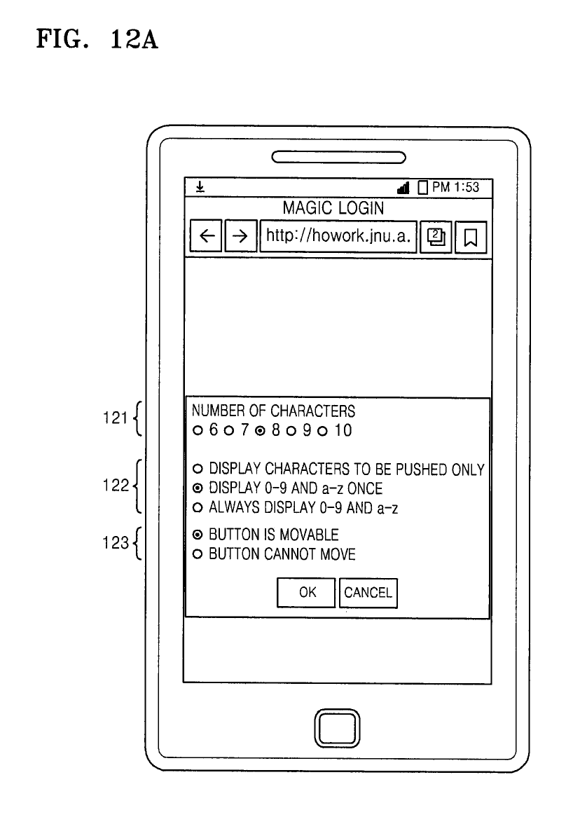

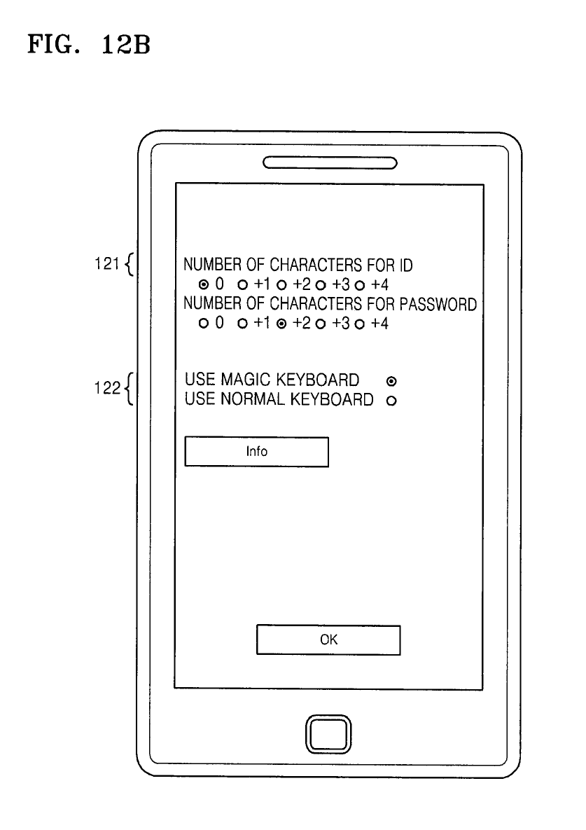

The setup key 97 is a menu key for allowing the user to manipulate in order to change settings of the personalized virtual keyboard. When the setup key 97 is manipulated, “a character number selection item”, “a default virtual keyboard selection item”, “a button movability selection item”, and the like may be set up as shown in FIGS. 12A and 12B. Herein the number of buttons indicates the number of character keys.

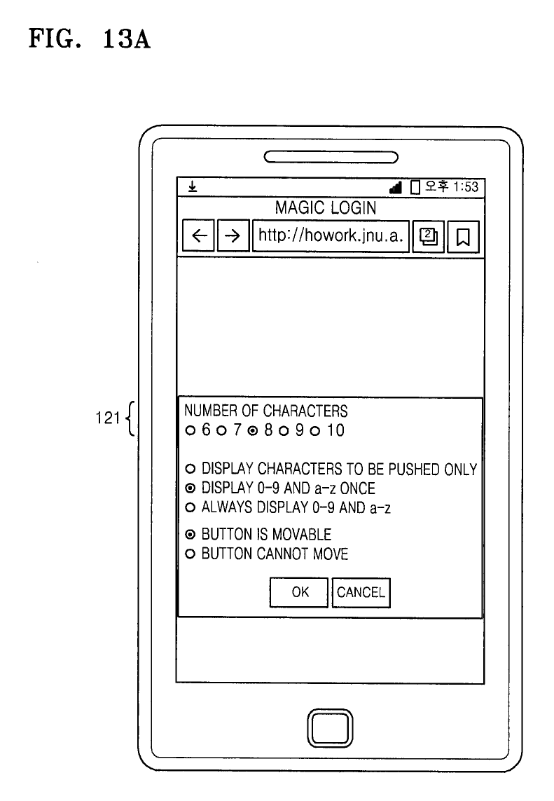

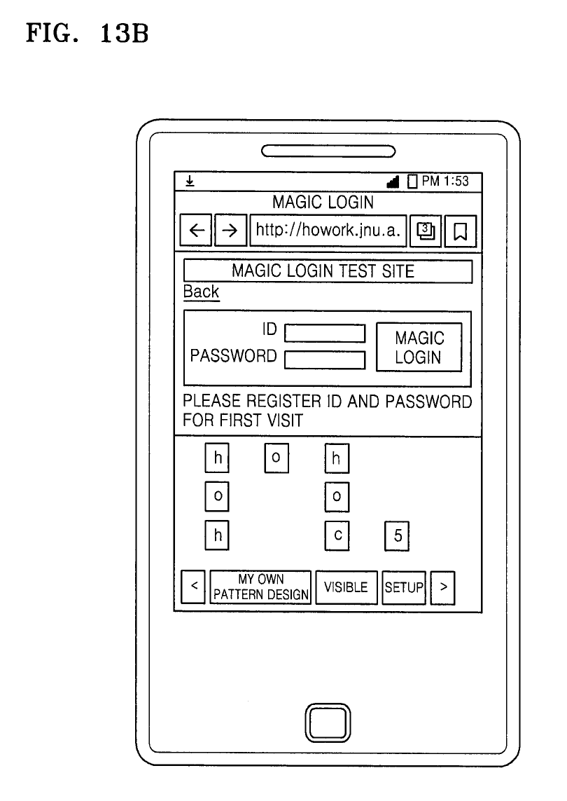

The character number selection item provides an environment for setting how many characters further appear besides “the number of characters of personal information”. For example, since the number of characters included in the illustrated ID “sbmaum” is 6, an environment as shown in FIG. 12A from which one of 6 to 10 is selected or an environment as shown in FIG. 12B from which one of “the numbers of characters, +1, +2, +3, and +4” is selected is provided. When the user selects “6”, the personalized virtual keyboard including only the character keys forming the personal information is maintained as shown in FIG. 6A or 9A. However, when a number other than “6” is selected, e.g., when “8” or “+2” is selected as shown in FIG. 13A, two arbitrary character keys (e.g., a character key “c” and a character key “5”) are additionally displayed as shown in FIG. 13B. However, when the number of character keys forming the personalized virtual keyboard exceeds a threshold value (e.g., 18), a default virtual keyboard is selected and displayed.

Alternatively, the number of character keys may be set by a server. In this case, when the number of characters is set by the server, all information devices display characters corresponding to the number set by the server. For example, the server may set so as for each information device to display only characters included in personal information, to display at least eight characters including the characters included in the personal information, to display two more characters in addition to the characters included in the personal information, or the like.

The default virtual keyboard selection item provides an environment from which one of the use of a personalized virtual keyboard (“display only characters to be pushed” in FIG. 12A or “use a magic keyboard” in FIG. 12B), the temporary use of a default virtual keyboard (“display 0 to 9 and a to z once” in FIG. 12A or “use a normal keyboard” in FIG. 12B), and the continuous use of a default virtual keyboard (“always display 0 to 9 and a to z” in FIG. 12A or “use a normal keyboard” in FIG. 12B) is selected.

The temporary use of a default virtual keyboard is selected when the user desires to change settings of personal information (an ID or a password) or when another person desires to use a corresponding information device, and when the user selects the temporary use of a default virtual keyboard, the default virtual keyboard as shown in FIG. 4 is displayed on the screen 11.

The continuous use of a default virtual keyboard is selected when the user desires not to use a personalized virtual keyboard, and in this case, a personalized virtual keyboard use selection environment may be provided in a personal information input screen image.

A case where a default virtual keyboard is supposed to be used will now be described in more detail. First, before a personalized virtual keyboard according to an embodiment of the present invention is generated, the user is supposed to input personal information through the default virtual keyboard. In addition, when another person uses my information device, the default virtual keyboard should be provided so as to be able to input personal information of another person. In addition, when personal information is to be changed, the default virtual keyboard is necessary to input new personal information. In these cases, when the user selects the temporary use of a default virtual keyboard, the default virtual keyboard as shown in FIG. 4 is displayed on the screen 11. When the user inputs new personal information, a personalized virtual keyboard corresponding to the newly inputted personal information may be newly generated and stored.

The information device 1 allows the user to select the use of a personalized virtual keyboard or the use of a default virtual keyboard, thereby allowing the user to freely select and use the personalized virtual keyboard or the default virtual keyboard.

### [Input of Personal Information by Using Personalized Virtual Keyboard]

When the user desires to input personal information by using a personalized virtual keyboard, if the user selects an arbitrary personal information input window on a personal information input screen image, the personalized virtual keyboard corresponding to the personal information is displayed as shown in FIG. 6A, 6B, 8A, 8B, 10B, 11, or 13B. The user sequentially selects character keys (regardless of displaying characters) corresponding to the personal information desired by the user to input by using the personalized virtual keyboard, thereby inputting the characters selected by the user into the personal information input window. Herein, a method by which the user selects character keys includes a method of sequentially dragging corresponding character keys, a method of sequentially touching corresponding character keys, a method of locating a mouse cursor on a corresponding character key and clicking the mouse cursor, and the like.

The character string inputted by the user is encrypted by a typical encryption method and transmitted to the web service provision server 17 or the authentication server 18, and the web service provision server 17 or the authentication server 18 decrypts the inputted character string by a typical decryption method and performs authentication on the corresponding character string.

Alternatively, locations of character keys inputted by the user may be transmitted to the web service provision server 17 or the authentication server 18, and the web service provision server 17 or the authentication server 18 may acquire personal information inputted by the user by recognizing characters corresponding to the respective locations based on information about the locations of the inputted character keys.

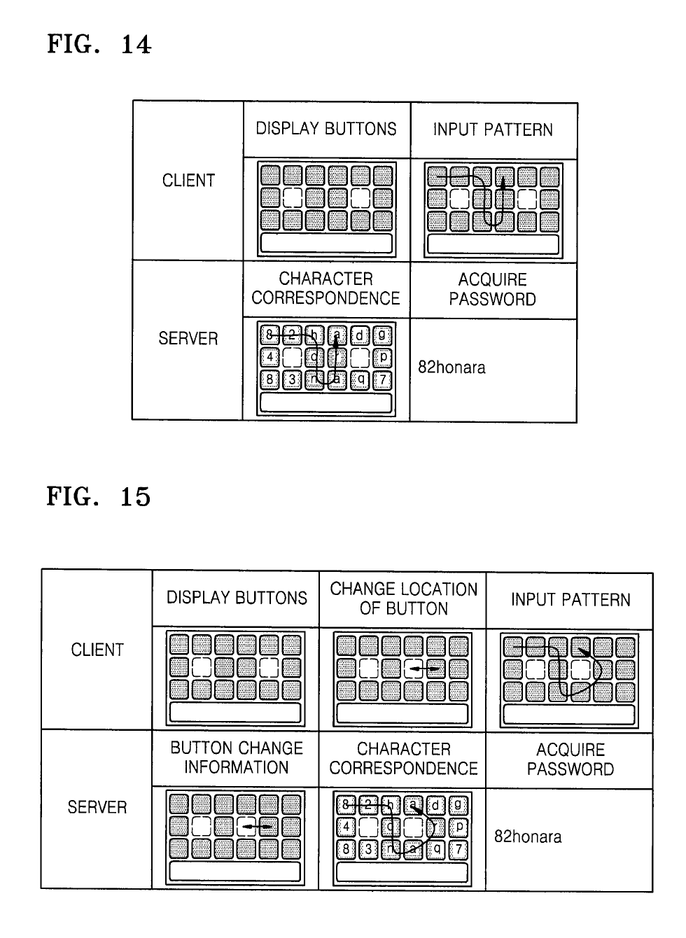

For example, as shown in FIG. 14, characters of character keys are not displayed on an information device, and when a user drags a pattern corresponding to personal information or selects keys corresponding to the personal information by using a personalized virtual keyboard, information on the dragged pattern or information on locations of the selected keys is transmitted to a server, and the server recognizes the selected character string from the dragged pattern information or the selected key location information. To this end, it would be obvious that the information device and the server share the personalized virtual keyboard of the user. In this case, since no trace of the personal information of the user is left behind in the information device and a communication network, security is more enhanced before.

### [Change Arrangement of Personalized Virtual Keyboard]

For a personalized virtual keyboard of which characters of character keys are invisible as shown in FIG. 14, the personalized virtual keyboard may be configured so as to be able to change locations of the character keys by a typical pattern design method as shown in FIG. 15.

In this case, an information device transmits location change information and user's key selection information to a server, and the server recognizes characters inputted by the user from the location change information of character keys (or personalized virtual keyboard arrangement information) and drag pattern information (or selected key location information).

Each character key of the personalized virtual keyboard may be always displayed at the same location or may be displayed according to an arrangement changed by the user in previous authentication.

Before the user inputs personal information by using the personalized virtual keyboard, the information device may request the user to change locations of character keys of the personalized virtual keyboard, and when the user changes a location of an arbitrary character key, the information device may transmit the location change information and location information of a key selected by the user to the server.

Although the technical idea has been described with reference to the accompanying drawings, the exemplary embodiments of the present invention have been illustratively described, and the present invention is not limited thereto. In addition, it would be obvious for those of ordinary skill in the art to be able to form various changes or modifications within the scope of the technical idea of the present invention.

### INDUSTRIAL APPLICABILITY

The present invention may be used for a method for generating and providing a personalized virtual keyboard according to personal information desired by a user to input when the personal information of the user is inputted through a personal portable terminal information device.

1. A method for providing a personalized virtual keyboard on a screen so as for a user to input personal information, the method comprising:
a first step of generating and storing a personalized virtual keyboard including character keys forming the personal information and having a same or less number of keys than the number of character keys on a default virtual keyboard; and
a second step of displaying the personalized virtual keyboard on the screen when the personal information is being inputted.

2. The method of claim 1, wherein the first step comprises:
a first sub-step of displaying the default virtual keyboard on an information device;
a second sub-step of performing authentication on the personal information of the user, which has been inputted through the default virtual keyboard; and
a third sub-step of generating and storing a personalized virtual keyboard corresponding to the personal information for which the authentication is successful.

3. The method of claim 2, wherein the second sub-step comprises performing the authentication on the personal information through an external server.

4. The method of claim 3, wherein the personalized virtual keyboard is generated and stored by any one of the information device and the external server or by both the information device and the external server.

5. The method of claim 4, wherein when the personalized virtual keyboard is generated and stored by both the information device and the external server, the personalized virtual keyboard is generated by combining information device side key data stored in the information device and server side key data stored in the external server.

6. The method of claim 5, wherein the server side key data is encrypted and transmitted to the information device, or the information device side key data is encrypted and stored in the information device.

7. The method of claim 1, wherein the second step of displaying the personalized virtual keyboard on the screen comprises arranging character keys forming the personalized virtual keyboard, in a preset predetermined pattern.

8. The method of claim 7, wherein the character keys forming the personalized virtual keyboard are sequentially arranged on the pattern.

9. The method of claim 1, wherein the personalized virtual keyboard may include character keys of which characters are invisible.

10. The method of claim 1, wherein the personalized virtual keyboard includes all duplicated character keys forming the personal information.

11. The method of claim 1, wherein the personalized virtual keyboard includes each one of duplicated character keys forming the personal information.

12. The method of claim 1, wherein in the personalized virtual keyboard displayed on the screen, locations of character keys forming the personalized virtual keyboard are changeable.

13. The method of claim 12, wherein the locations of the character keys are changed by a drag and drop method or by a method of selecting a character key to be moved and then selecting a location to which the selected character key is to be moved.

14. The method of claim 1, wherein in the personalized virtual keyboard displayed on the screen, characters displayed on character keys forming the personalized virtual keyboard are invisible.

15. The method of claim 1, wherein in the personalized virtual keyboard, the number of character keys displayed on the screen is changeable according to settings of the user.

16. The method of claim 1, wherein in the personalized virtual keyboard displayed on the screen, the number of character keys displayed on the screen is changeable according to a signal received from an external server.

17. The method of claim 1, wherein an information device provides an environment of selecting the use of the default virtual keyboard or the use of the personalized virtual keyboard.

18. The method of claim 1, further comprising a third step of transmitting location information of character keys sequentially selected from the personalized virtual keyboard displayed on an information device.

19. The method of claim 18, wherein arrangement information of character keys of the personalized virtual keyboard is further transmitted to an external server.
